(19) United States
(12) Patent Application Publication
(10) Pub. No.: US 2010/0072718 A1
(43) Pub. Date: Mar. 25, 2010

(54) Compactable Utility Laundry Pushcart

(76) Inventor: Raelene Jo Funk, Santa Marie, CA (US)

Correspondence Address: Raelene Jo Funk, 1240 W. Bethel Ln #31A, Santa Maria, CA, 93458, US

(21) Appl. No.: 12/481,432

(22) Filed: Jun. 9, 2009

Related U.S. Application Data
(60) Provisional application No. 61/098,677, filed on Sep. 19, 2008.

(51) Int. Cl. B62B 3/02

(52) U.S. Cl. 280/47.371

(57) ABSTRACT

I have invented a compactable utility laundry pushcart, with a weight activated rising/lowering bottom, with built in storage compartments for laundry detergents hangars and accessories, as well as change/money, keys, cupholder, etc . . . . It is to be durable with a 3-5 year lifespan, made for indoor, but more outdoor, hauling/transferring of personal laundry and laundry accessories.

### PREVIOUS FILING

This application emanates from a previously filed application 61/098,677 filed on Sep. 19, 2008

### FIELD OF THE INVENTION

The field of invention relates to cart structure, and more particularly pertains to a new compactable laundry cart apparatus wherein the same is arranged for the support and transport of various categories of laundry within various basket members.

### BACKGROUND OF THE INVENTION

My invention is a push cart made for hauling storing and transporting personal laundry, as well as accessories, whether indoor/outdoor . . . made out of durable plastic, put on an aluminum frame, with four 7-9 inch rubber alloy wheels all on all wheel suspension . . . with foot activated brakes. It will be verticle rectangle in shape. There will be an easy grip height adjustable handle. The handle will also have a push/twist switch built in, to allow user to be able to compact my invention into half of its size. The side that remains stationary will have built in storage compartments. One big compartment for detergents and accessories, with door access . . . lockable. This main compartment will have a removable shelf made out of durable plastic. By the handle, there will be a change/money compartment that comes with built in lock and key. Close to that compartment will be a built in open compartment for easy access to change keys etc . . . . Next to that will be a built in cup holder. The basket portion of my invention that compacts in, will have a track runner built in to assist with the weight activated rising/lowering bottom. This bottom will be connected to the stationary side of my invention,this side will have a track and shock system built in for the rising/lowering bottom to attach to and will be able to attach to the track and shock system built in to the compactable side, as well. In between the 2 halves of my invention, there will be a pull out personal folding table that snaps in to place parallel to the opening of the compactable basket portion of my invention. My invention will also be able to run off a 12 volt rechargable battery and motor. This will push my invention itself. Also an ipod station built into my invention. The compactable clothing recepticle side of my invention will have built in hangar slots for hanging clothes from hangars. This side, on the bottom, will have built in ventilation. I want plastic containers for detergents as apart of my invention, as well as cloth mesh collapsable laundry baskets.

### SUMMARY OF THE INVENTION

I came up with the idea for my invention by watching my mom whose had 10 surgeries, mostly back, but also including breast removal from cancer . . . which caused lymphdema in her arm. We live in an apartment that has onsite washer/dryer facilities, and we bought a trash can with 2 wheels to haul our laundry to these facilities, which are about 300 feet or more away. In the laundry hauling process it was hard for my mom to pull the trash can fill with clothes in it, and yet still have to go back to the apartment to get the detergent and softners and change. With all of her surgeries that process was too much, just as collecting laundry in the house was. It was hard for my mom to bend down to the bottom of the trashcan on wheels and reach the clothes there, just as it is for me or my brother, being that he is so tall. so I thought wouldnt it be a lot more simple to be able to push instead of pull, but have the option for both, a cart on big durable outdoor but can be used for indoor wheels . . . built on suspension. and a handle that adjust to your height, and I thought it would be so much more simple to be able to have your detergents and laundry accessories hangars and all, a permanent place of storage no matter where my invention is stored, and your money. Being that apartments are space limited, I want my invention to be able to compact into half of its size, #1 to store in a closet or out of the way(still with all storage compartments being utilized) #2 so if you want to go to a public laundry facility, you can load your mesh laundry baskets filled with laundry into my invention, roll it to your car, unload your baskets, compact my invention, and load into the back seat or trunk, the whole time my invention is being moved around, your detergents and accessories will still be intact in their storage compartments. You can compact my invention and put away, or you can keep it out and use it has a hamper. My invention improves hauling transporting, and storing laundry and laundry accessories at all times. It improves space for user in a few ways. It makes doing laundry less strenuous physically as well as mentally.

I have invented a compactable utility laundry pushcart, with a weight activated rising/lowering bottom, with built in storage compartments for laundry detergents hangars and accessories, as well as change/money, keys, cupholder, etc . . . . It is to be durable with a 3-5 year lifespan, made for indoor, but more outdoor, hauling/transferring of personal laundry and laundry accessories.

### BRIEF DESCRIPTION OF THE DRAWING

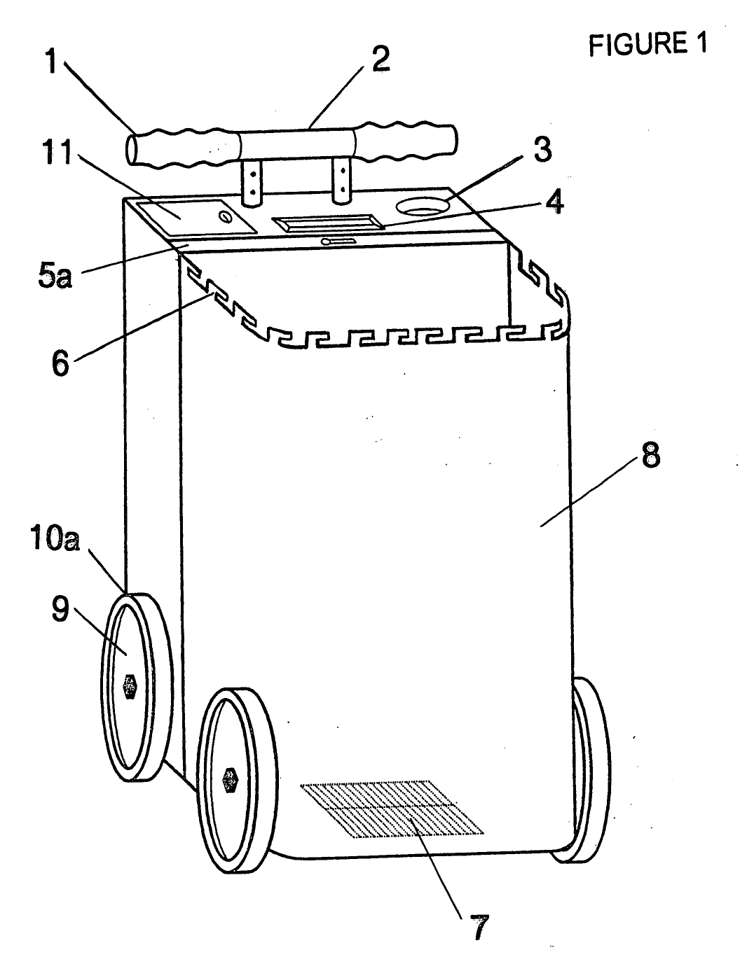

1. FIG. 1 is the top and front perspective of the device

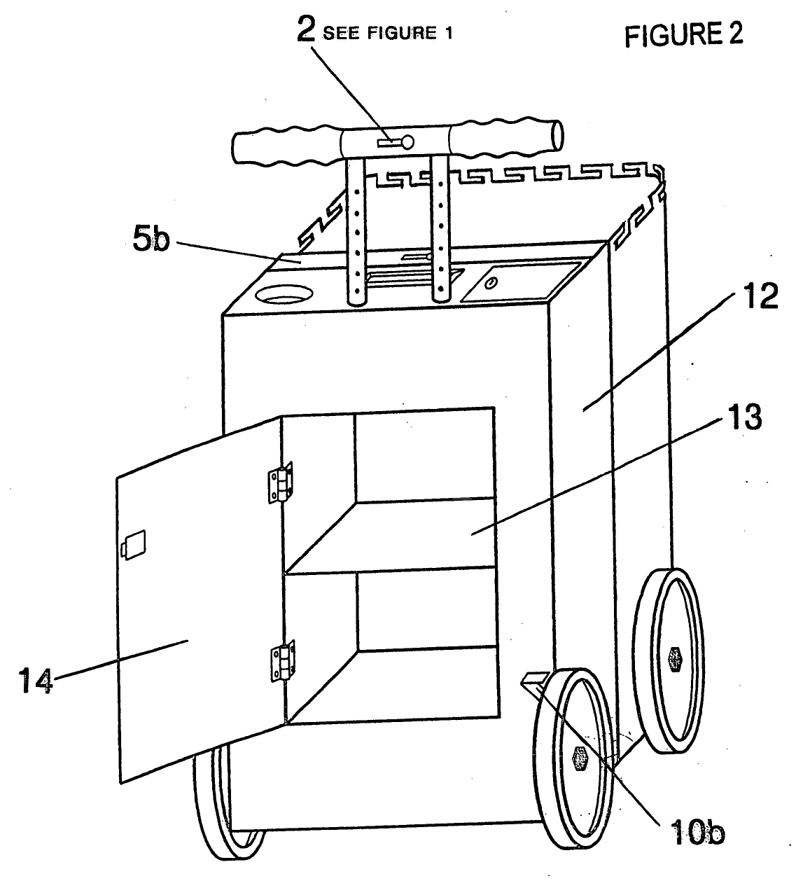

2. FIG. 2 is the front/interior perspective view of the device

### DETAILED DESCRIPTION OF THE INVENTION

FIG. 1 Descriptions

FIG. 1 shows the front view of my compactable laundry utility pushcart. Here is the (1) oversized easy grip, height adjustable rubber handle, that has a hand control for self propelled models, wired into the aluminum tubing used to frame the handle as well as entire pushcarts body. (2) is a thumb push and twist button switch, that triggers the aluminum frame to collapse, causing my device to compact into an accordion type effect. (3) is a built in cup holder. (4) is a built in open compartment that measures approx. 4″ wide by 10″ long, this could be used for keys, loose change, personal items, etc . . . (5a) is a pull out plastic table, that self locks into place, providing a personal folding surface for user. (6) hangar slots built into the rim of the basket portion of my device. (7) This is the hamper compartment that has a buttom that runs on built in runners, and a shock system, that allows the bottom to rise and/or lower dure to weight and lack there of. This hamper compartment also compacts by the push/twist of the button located (see FIG. 1 (2)) into the stationary side (see FIG. 2 (12)), for easy storage and handling. (8) Built into the hamper compartment (see FIG. 1 (7)) located underneath the rise/lowering buttom, is built in ventilation slots. (9) four alloy/rubber 8 inch wheels, built on all wheel suspension . . . 2 wheels on one side, 2 on the other. (10a) Foot brakes. (11) This is a built in lock box w/ key compartment to store money, personal items, etc . . . with *optional with model* a built in ipod/mp3 port/dock.

FIG. 2 Descriptions

FIG. 2 is the rear view of my compactable laundry utility push cart. (5b) is the pull out plastic folding table that self locks into place on the stationary side of my device. (12) This is the main component of my device. This side holds all mechanics i.e. motor, wiring etc . . . storage compartments, and receives the compactable hamper portion upon compacting. (13) This is the main storage compartment that contains a removable/adjustable self locking plastic shelf. This compartment is also where the main power supply will be located, for the electronic/motorized *optional* features. (10b) Foot brakes that locks/releases the wheels motion. (14) This is the hinged key lockable door that goes to the main storage compartment (see FIG. 2 (13)). Both (11) and (14) will share the same key.

What is claimed as being new and desired to be protected by Letters Patent of the United States is as follows:

1. I claim a compactable utility laundry pushcart, comprising;
a. height adjustable handle (1)
b. collapse button release (2)
c. cup holder (3)
d. storage compartments (4)
e. self locking pullout plastic tray (5)
f. hanger slots (6)
f. built in hamper compartment (7)
g. foot breaks (10)

2. I claim a compactable utility laundry pushcart of claim 1, wherein the pushcart laundry compartment embodies weight sensors.

3. I claim a compactable utility laundry pushcart of claim 1, wherein the pushcart embodies wheel locks.

4. I claim a compactable utility laundry pushcart of claim 1, wherein the pushcart embodies lockable storage compartments.
